(19) United States
(12) Patent Application Publication
(10) Pub. No.: US 2026/0261972 A1
(43) Pub. Date: Sep. 3, 2026

(54) SECURITY ENHANCEMENTS FOR LOW-POWER WAKE-UP SIGNAL

(71) Applicant: QUALCOMM Incorporated, San Diego, CA (US)

(72) Inventors: Weimin DUAN, San Diego, CA (US); Huilin XU, Temecula, CA (US); Jing LEI, San Diego, CA (US)

(21) Appl. No.: 19/067,090

(22) Filed: Feb. 28, 2025

(51) Int. Cl. H04W 52/02; H04L 27/26

(52) U.S. Cl. CPC H04W 52/0235; H04L 27/2607; H04L 27/261

(57) ABSTRACT

Various aspects of the present disclosure generally relate to wireless communication. Some aspects more specifically relate to improving the robustness of a low-power wake-up signal (LP-WUS) against jamming or interference. In some aspects, an LP-WUS may be implemented according to one or more verification schemes that may confirm the LP-WUS. For example, one or more bits used for error correction included in the LP-WUS may be masked, such as by using scrambling procedures that may be associated with an identifier known to a user equipment (UE), and the UE may unmask the one or more bits to confirm the LP-WUS. Additionally or alternatively, multiple repetitions of the LP-WUS may be transmitted, and each repetition may have a respective phase code applied, such that the UE may confirm the LP-WUS by decoding each repetition of the LP-WUS in accordance with the respective phase codes.

### FIELD OF THE DISCLOSURE

Aspects of the present disclosure generally relate to wireless communication and specifically relate to techniques, apparatuses, and methods associated with security enhancements for low-power wake-up signal.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples, a user equipment (UE) may be equipped with a low-power wake-up radio (LP-WUR) that supports reception of messages while the UE is in a low power state. For example, in the low power state, the LP-WUR may be active and may be used to monitor for a low-power wake-up signal (LP-WUS) while a main radio of the UE is off or in a deep sleep state. Accordingly, the UE may monitor for signaling using the LP-WUR while in the sleep state, which may lower power consumption relative to monitoring using the main radio. In some examples, a network node may transmit the LP-WUS to indicate an availability of a data transmission for the UE. If the UE detects the LP-WUS using the LP-WUR, the UE may activate the main radio and monitor for the data transmission using the main radio.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node via a low-power wake-up radio (LP-WUR), a low-power wake-up signal (LP-WUS) associated with a verification procedure for confirmation of the LP-WUS. The processing system may be configured to cause the UE to monitor, via a main radio, for a control message from the network node in accordance with the verification procedure.

Some aspects described herein relate to a network node. The network node may include a processing system. The processing system may include one or more processors and one or more code-storing memories coupled with the one or more processors. The processing system may be configured to cause the network node to transmit an LP-WUS to a UE, the LP-WUS associated with a verification procedure for confirmation of the LP-WUS. The processing system may be configured to cause the network node to transmit, to the UE, a control message in accordance with the verification procedure

Some aspects described herein relate to a method for wireless communication by a UE. The method may include receiving, from a network node via an LP-WUR, an LP-WUS associated with a verification procedure for confirmation of the LP-WUS. The method may include monitoring, via a main radio, for a control message from the network node in accordance with the verification procedure.

Some aspects described herein relate to a method of wireless communication performed by a network node. The method may include transmitting an LP-WUS to a UE, the LP-WUS associated with a verification procedure for confirmation of the LP-WUS. The method may include transmitting, to the UE, a control message in accordance with the verification procedure.

Some aspects described herein relate to a non-transitory computer-readable medium that stores a set of instructions for wireless communication by a UE. The set of instructions, when executed by one or more processors of the UE, may cause the UE to receive, from a network node via an LP-WUR, an LP-WUS associated with a verification procedure for confirmation of the LP-WUS. The set of instructions, when executed by one or more processors of the UE, may cause the UE to monitor, via a main radio, for a control message from the network node in accordance with the verification procedure.

Some aspects described herein relate to a non-transitory computer-readable medium that stores a set of instructions for wireless communication by a network node. The set of instructions, when executed by one or more processors of the network node, may cause the network node to transmit an LP-WUS to a UE, the LP-WUS associated with a verification procedure for confirmation of the LP-WUS. The set of instructions, when executed by one or more processors of the network node, may cause the network node to transmit, to the UE, a control message in accordance with the verification procedure.

Some aspects described herein relate to an apparatus for wireless communication. The apparatus may include means for receiving, from a network node via an LP-WUR, an LP-WUS associated with a verification procedure for confirmation of the LP-WUS. The apparatus may include means for monitoring, via a main radio, for a control message from the network node in accordance with the verification procedure.

Some aspects described herein relate to an apparatus for wireless communication. The apparatus may include means for transmitting an LP-WUS to a UE, the LP-WUS associated with a verification procedure for confirmation of the LP-WUS. The apparatus may include means for transmitting, to the UE, a control message in accordance with the verification procedure.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a low-power wake up radio (LP-WUR) and a low-power wake-up signal (LP-WUS).

FIG. 4 is a diagram illustrating an example of LP-WUS modulation.

FIG. 5 is a diagram illustrating an example of LP-WUS repetitions to reduced missed detection.

FIG. 6 is a diagram illustrating examples of switching LP-WUS detection mechanisms to reduce missed detection.

FIG. 7 is a flowchart illustrating an example process that supports security enhancements for LP-WUS.

FIG. 8 is a flowchart illustrating an example process that supports security enhancements for LP-WUS.

FIG. 9 is a diagram of an example apparatus for wireless communication that supports security enhancements for LP-WUS.

FIG. 10 is a diagram of an example apparatus for wireless communication that supports security enhancements for LP-WUS.

### DETAILED DESCRIPTION

In some examples, a user equipment (UE) may be equipped with a low-power wake-up radio (LP-WUR) that supports reception of messages while the UE is in a low power state. For example, while operating in the low power state, the LP-WUR may be active and may be used to monitor for a low-power wake-up signal (LP-WUS), while a main radio of the UE is off or in a deep sleep state. When the UE detects an LP-WUS using the LP-WUR, the UE may activate the main radio and monitor for signaling (for example, control signaling) from a network node. In some examples, the LP-WUS may include a signal modulated in accordance with on-off keying (OOK) modulation, where information associated with the LP-WUS is indicated using on symbols and off symbols (for example, an on-off pattern). Accordingly, by using OOK modulation, the LP-WUS may support reception using a low complexity receiver architecture for the LP-WUR, which may use a lower operating power and may be associated with lower frequency accuracy requirements and a lower cost oscillator, relative to a receiver that supports reception of an LP-WUS using coherent modulation techniques such as orthogonal frequency division multiplexing (OFDM).

In some examples, the LP-WUS may additionally include transmission of one or more overlaid sequences. For example, the one or more overlaid sequences may be transmitted during each on symbol of an LP-WUS modulated in accordance with OOK modulation. In some cases, the one or more overlaid sequences may carry the same information as the LP-WUS modulated in accordance with OOK modulation, or may be random (for example, pseudo-random) phase signals. Accordingly, by implementing overlaid signals, the LP-WUS may support faster or more reliable detection for the UE, relative to using only an OOK-modulated signal. Additionally, the overlaid sequences may be transmitted so as to flatten the frequency spectrum of the LP-WUS (for example, when using random phase signals), which may support more efficient usage of communication resources and improved robustness to channel fading.

In some cases, however, an LP-WUS may be subject to jamming or interference, which may create challenges in receiving signaling for the UE in the sleep state that monitors for the LP-WUS. For example, because an LP-WUS may use OOK modulation, where on symbols and off symbols may be differentiated using differences in observed signal amplitude levels, the LP-WUS may be more subject to jamming or interference relative to signals modulated using coherent modulation techniques, as the jamming or interference may affect the observed signal amplitude strength of the LP-WUS. Additionally, even if an LP-WUS implements overlaid signals, the LP-WUS may still be subject to jamming, which may be facilitated if the overlaid signals contain the same information as the OOK-modulated signal. If the LP-WUS experiences jamming or interference, the UE may miss detection of the LP-WUS, and the UE would not activate the main radio and may miss reception of signaling intended for the UE. Additionally or alternatively, the UE may falsely interpret jamming or interference as an LP-WUS, which may cause the UE to activate the main radio, and monitor using the main radio, even if no signaling is being transmitted to the UE, thereby increasing the power consumption of the UE.

Various aspects relate generally to LP-WUS security enhancements. Some aspects more specifically relate to improving the robustness of an LP-WUS against jamming or interference. In some aspects, an LP-WUS may be implemented according to one or more verification schemes that may confirm the LP-WUS (for example, double verification). For example, one or more bits used for error correction (for example, cyclic redundancy check (CRC) bits) included in the LP-WUS may be masked, such as by using scrambling procedures that may be associated with an identifier known to the UE, and the UE may unmask the one or more bits to confirm the LP-WUS. Additionally or alternatively, multiple repetitions of the LP-WUS may be transmitted, and each repetition may have a respective phase code applied, such that the UE may confirm the LP-WUS by decoding each repetition of the LP-WUS in accordance with the respective phase codes. Additionally or alternatively, after detecting the LP-WUS, the UE may monitor for a reference signal (for example, a demodulation reference signal (DMRS)) from the network node that confirms the LP-WUS.

In some aspects, the UE may be configured to implement techniques to reduce the likelihood of a missed LP-WUS due to jamming or interference. For example, the UE may be configured to activate the main radio and perform monitoring using the main radio after a duration (for example, a duration from a previous control channel monitoring occasion using the main radio), even if no LP-WUS is detected. Additionally or alternatively, the UE may be configured to perform jamming or interference detection and may switch between monitoring using the LP-WUR and the main radio in accordance with the detection of jamming or interference. For example, if the UE detects an LP-WUS with jamming or interference using the LP-WUR, the UE may switch to using the main radio for LP-WUS monitoring. In some aspects, if the UE detects an LP-WUS without jamming after switching to using the main radio, the UE may switch to using the LP-WUR for LP-WUS monitoring (for example, the UE may switch after a duration from the detection of an LP-WUS without jamming).

Particular aspects of the subject matter described in this disclosure can be implemented to realize one or more of the following potential advantages. In some examples, the described techniques can be used to reduce the likelihood of the UE missing reception of an LP-WUS, which may improve the detection of control signaling intended for the UE. Additionally or alternatively, by implementing additional verification for the LP-WUS, the UE may be less likely to falsely detect an LP-WUS. Accordingly, the described techniques may support reducing power consumption for the UE associated with false detection of an LP-WUS, as the UE may continue monitoring using the LP-WUR. Additionally, by configuring the UE to monitor for LP-WUSs using the main radio after detecting an LP-WUS with jamming, the described techniques may improve the reception of subsequent LP-WUSs. For example, the main radio may support improved jamming or interference mitigation while allowing the UE to monitor for control signaling intended for the UE, thereby reducing the likelihood of missed transmissions.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

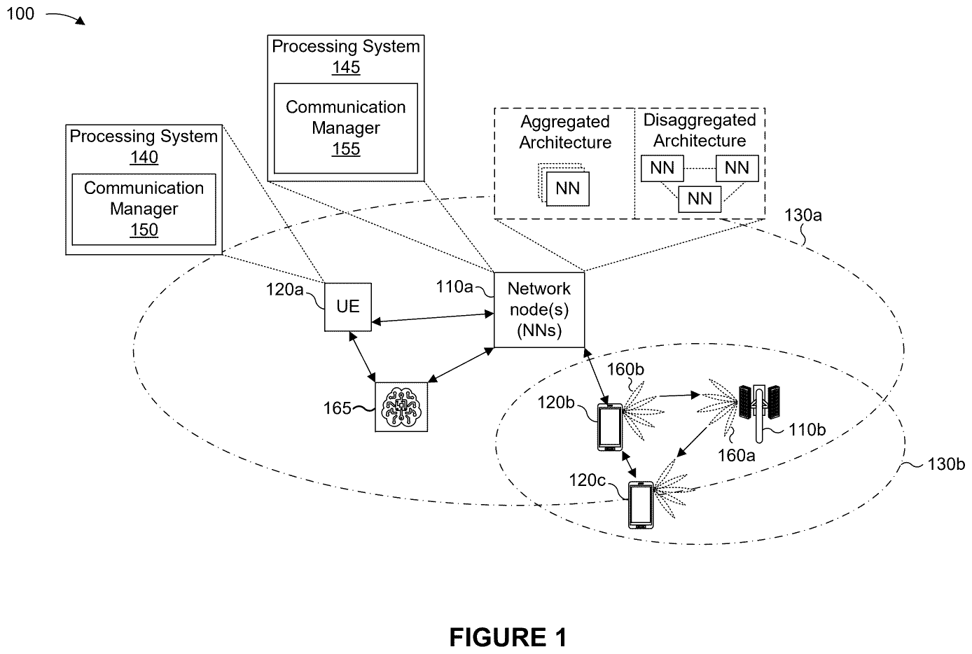

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, in accordance with a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified in accordance with different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) in accordance with changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder associated with one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, associated with measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, in accordance with a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node via an LP-WUR, an LP-WUS associated with a verification procedure for confirmation of the LP-WUS; and monitor, via a main radio, for a control message from the network node in accordance with the verification procedure. Additionally or alternatively, the communication manager 150 may perform one or more other operations described herein.

In some aspects, the network node 110 may include a communication manager 155. As described in more detail elsewhere herein, the communication manager 155 may transmit an LP-WUS to a UE, the LP-WUS associated with a verification procedure for confirmation of the LP-WUS; and transmit, to the UE, a control message in accordance with the verification procedure. Additionally or alternatively, the communication manager 155 may perform one or more other operations described herein.

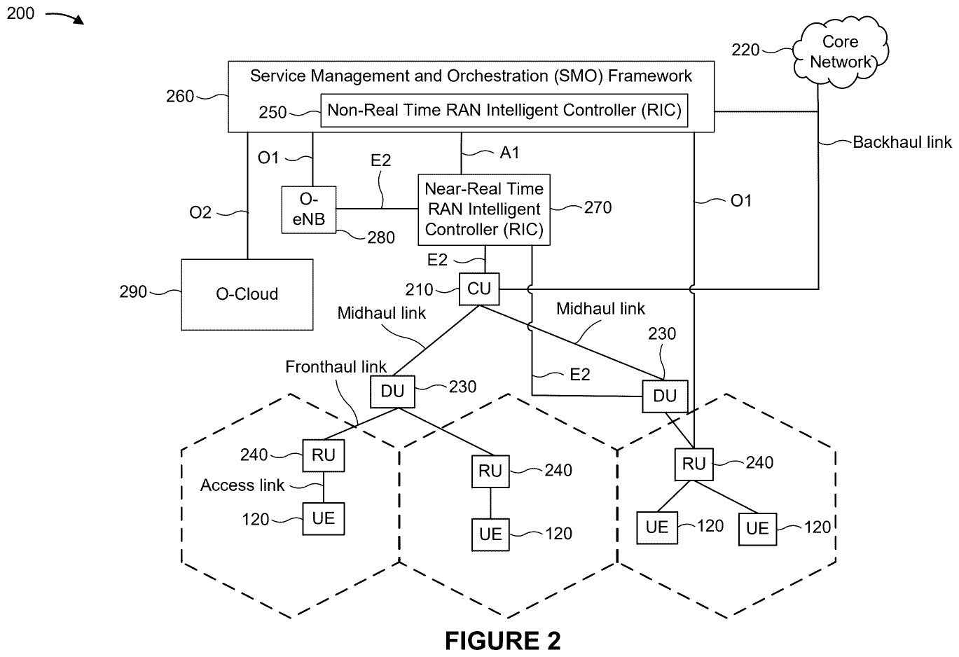

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

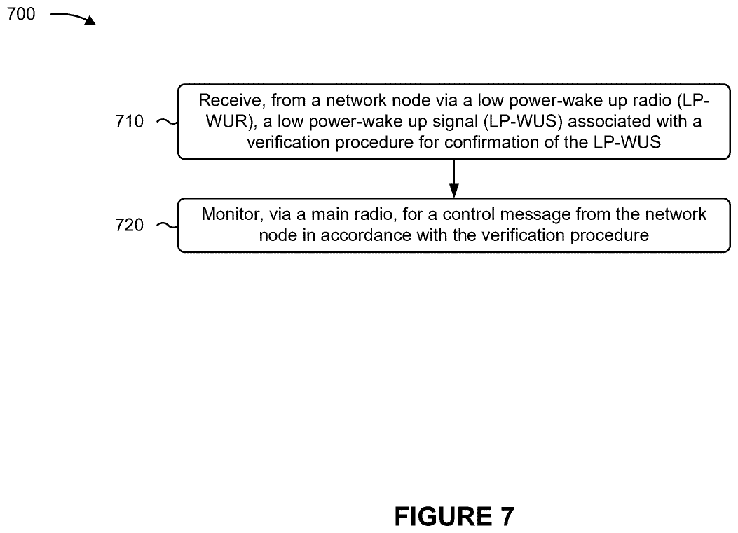

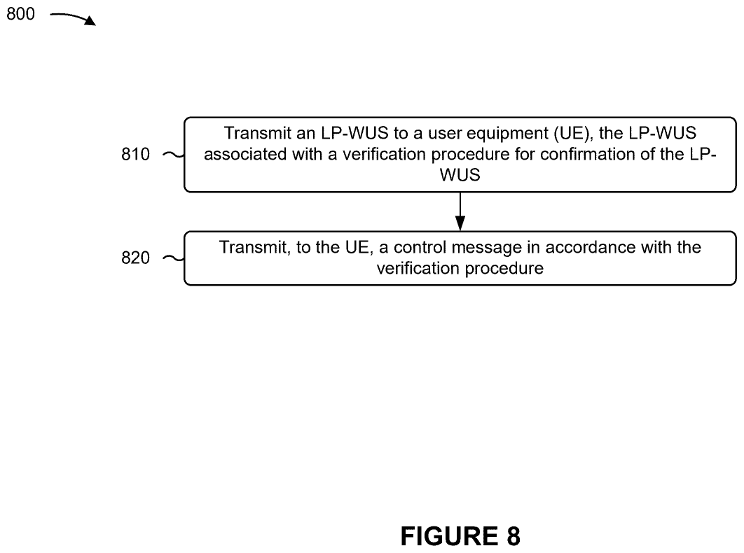

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with security enhancements for LP-WUSs, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

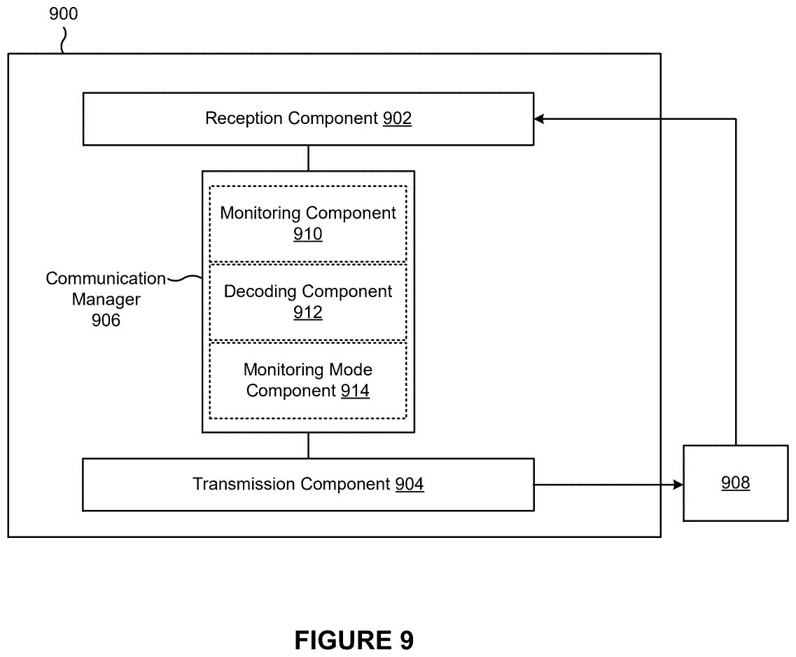

In some aspects, the UE 120 includes means for receiving, from a network node 110 via LP-WUR, an LP-WUS associated with a verification procedure for confirmation of the LP-WUS; or means for monitoring, via a main radio, for a control message from the network node 110 in accordance with the verification procedure. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

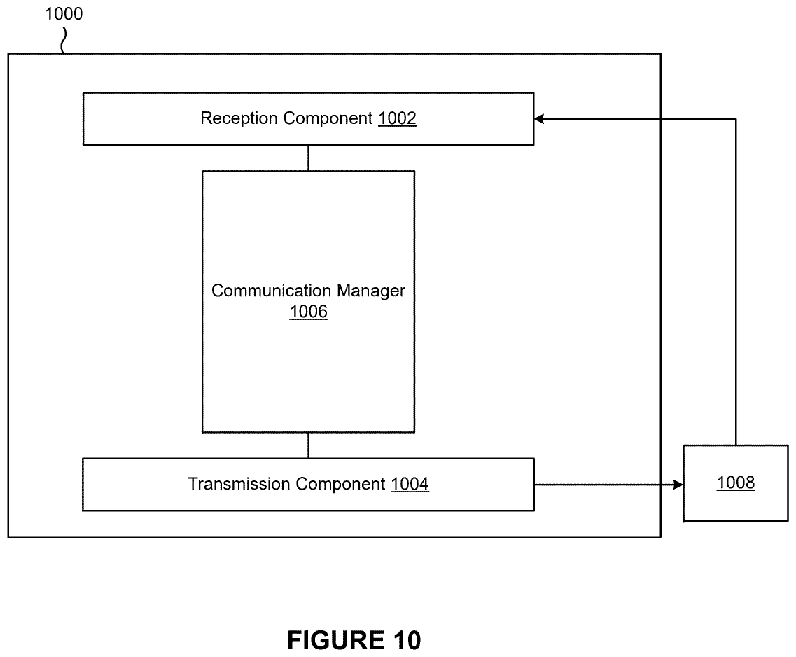

In some aspects, the network node 110 includes means for transmitting an LP-WUS to a UE 120, the LP-WUS associated with a verification procedure for confirmation of the LP-WUS; or means for transmitting, to the UE 120, a control message in accordance with the verification procedure. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

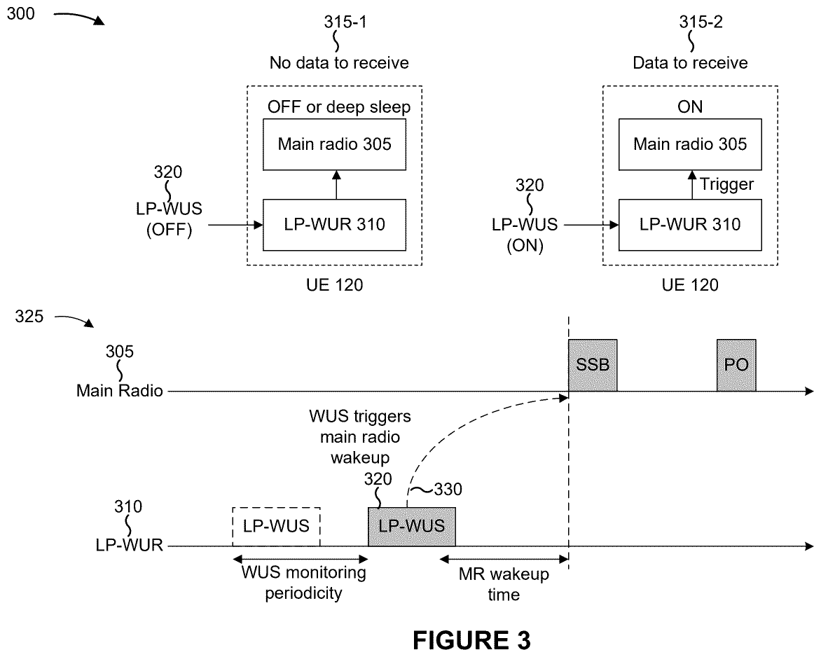

FIG. 3 is a diagram illustrating an example 300 of an LP-WUR and an LP-WUS. As shown in FIG. 3, a UE 120 may be equipped with a communication system that includes a main radio (illustrated as “MR”) 305 and an LP-WUR 310 to reduce power consumption and enable low latency. For example, power saving and low latency are often conflicting goals because placing one or more components into a sleep state more often to reduce power consumption also increases latency (for example, because data cannot be transmitted or received while the one or more components are in the sleep state), and because reducing the time that one or more components spend in a sleep state to reduce latency can lead to increased power consumption. Accordingly, as shown in FIG. 3, the UE 120 may be equipped with the LP-WUR 310, which may be considered a companion receiver that can be used with a main radio 305 to reduce power consumption and latency.

For example, in some aspects, the UE 120 may generally use the main radio 305 to transmit or receive user data, and the main radio 305 may be turned off or operated in a deep sleep state unless there is user data to transmit or receive. Furthermore, the LP-WUR 310 may serve as a simple wake-up receiver for the main radio 305, and the LP-WUR 310 may be active and monitoring for an LP-WUS while the main radio 305 is off or in the deep sleep state. For example, reference number 315-1 depicts a first state associated with the main radio 305 and the LP-WUR 310 where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 (such as from a network node 110) and may provide a trigger to wake or otherwise activate the main radio 305 responsive to detecting the LP-WUS 320. Accordingly, the main radio 305 may then transmit or receive user data.

In general, the LP-WUR 310 may consume very little power (for example a target power consumption less than 100 microwatts (μW) in the active state), which may be achieved using simple modulation schemes (for example, OOK modulation), a narrow bandwidth (for example, less than 5 MHz), or other suitable techniques. In this way, the LP-WUR 310 can be used to reduce the time that the main radio 305 spends in an on state or may avoid unnecessarily waking the main radio 305 from the off or deep sleep state when there is no user data to transmit or receive, which tends to be costly from a power consumption perspective. Furthermore, because the LP-WUR 310 has a very low power consumption, the LP-WUR 310 can be used to frequently or continuously perform LP-WUS monitoring, which may improve latency because the main radio 305 can be woken up when there is user data that the main radio 305 needs to receive. For example, the LP-WUR 310 may not suffer from the latency versus power efficiency tradeoff associated with duty cycling schemes, such as DRX. Furthermore, in addition to performing LP-WUS monitoring, which may be used for paging reception, the LP-WUR 310 may monitor a low power synchronization signal (LP-SS) for time and frequency tracking and radio resource management (RRM) measurement. In this way, by monitoring the LP-SS, serving cell or neighbor cell monitoring can be offloaded from the main radio 305 to the LP-WUR 310 to reduce how often the main radio 305 is woken up, which can further reduce power consumption.

In some aspects, the LP-WUR 310 may include an OOK WUR (also referred to as an envelope detector (ED) WUR). An OOK WUR may only detect the amplitude (such as the magnitude) of a received signal. A UE 120 that uses an OOK WUR may detect the phase of a received signal by activating the main radio 305.

In some aspects, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 325, one application of the LP-WUR 310 is to monitor the LP-WUS 320 for paging monitoring, which can be used to reduce unnecessary paging reception performed by the main radio 305. For example, as shown in FIG. 3, the LP-WUR 310 may be configured to monitor for an LP-WUS 320 (while the main radio 305 is off or in a deep sleep state) in accordance with a wake-up signal (WUS) monitoring periodicity. For example, the LP-WUR 310 may monitor for the LP-WUS 320 in periodic LP-WUS monitoring occasions that are spaced in time in accordance with the WUS monitoring periodicity. Alternatively, although not explicitly shown in FIG. 3, the LP-WUR 310 may be configured to continuously monitor for the LP-WUS 320. In general, a network node may transmit an LP-WUS 320 to a UE 120 only in cases where there is a paging message that needs to be sent to the UE 120 while the UE 120 is in an idle or inactive state (such as an RRC idle or RRC inactive state). In such cases, as shown by reference number 330, the LP-WUR 310 may receive and detect the LP-WUS 320, which may trigger the LP-WUR 310 to wake up the main radio 305. In some aspects, the LP-WUS 320 may be a sequence-based WUS, which may include a predefined set of sequences (implemented, for example, using OOK modulation or phase modulation). As shown, the main radio 305 may wake up after a main radio wake-up time, and may then start to monitor one or more SSB transmissions to obtain synchronization with the network node before monitoring and receiving the paging message in a subsequent PO. Otherwise, in cases where the LP-WUR 310 does not detect the LP-WUS 320, the main radio 305 may remain in the deep sleep state to save power.

In some aspects, an LP-WUS 320 may be implemented according to one or more verification schemes which may confirm the LP-WUS 320 (for example, double verification). For example, one or more bits used for error correction (for example, CRC bits) included in the LP-WUS 320 may be masked, such as by using additional scrambling procedures that may be associated with an identifier known to a UE 120, and the UE 120 may descramble the one or more bits to confirm the LP-WUS 320. Additionally or alternatively, multiple repetitions of the LP-WUS 320 may be transmitted, and each repetition may have a respective phase code applied, such that the UE may confirm the LP-WUS 320 by decoding each repetition of the LP-WUS 320 in accordance with the respective phase codes. Additionally or alternatively, after detecting the LP-WUS 320, a network node 110 may transmit, and the UE 120 may monitor for, a reference signal (for example, a DMRS) that confirms the LP-WUS 320.

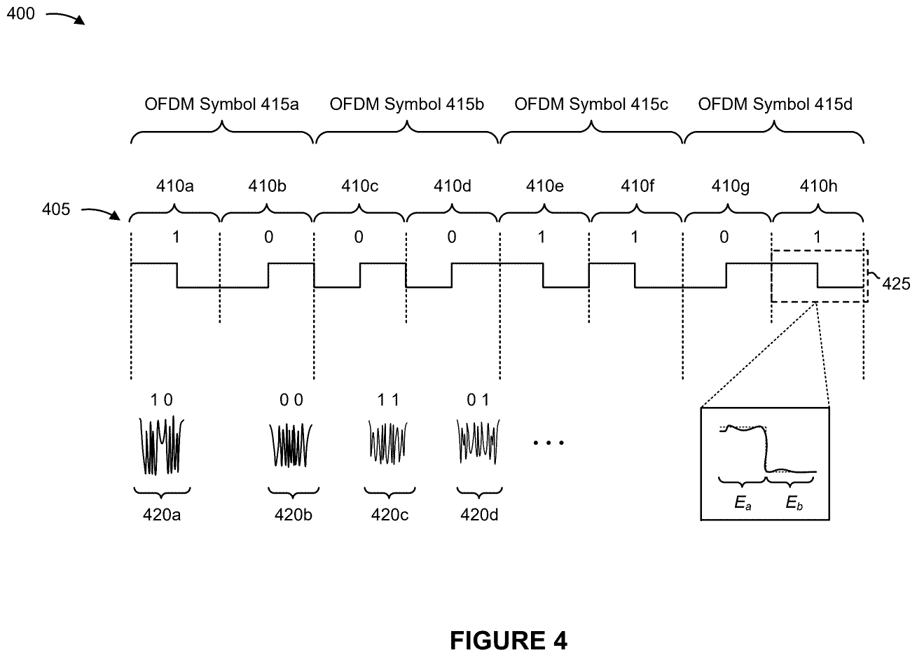

FIG. 4 is a diagram illustrating an example 400 of LP-WUS modulation. As shown in FIG. 4, the LP-WUS may include a signal 405 modulated in accordance with OOK modulation, which may be an example of non-coherent modulation, as described herein. The signal 405 may include one or more on symbols and one or more off symbols, which may form an on-off pattern that indicates information associated with the LP-WUS.

In some cases, an LP-WUS may be modulated in accordance with OOK modulation. For example, the LP-WUS may include one or more OOK symbols 410, and each OOK symbol 410 may correspond to an on duration or an off duration. In some examples, OOK symbols 410 corresponding to an on duration may indicate a first value (for example, a value of one), and OOK symbols 410 corresponding to an off duration may indicate a second value (for example, a value of zero). In some cases, to determine whether an OOK symbol 410 corresponds to an on duration or an off duration, the UE 120 may compare an amplitude of the LP-WUS to an amplitude threshold.

In some examples, as shown in FIG. 4, the signal 405 may be modulated in accordance with OOK modulation using Manchester encoding. For example, the signal 405 may include one or more OOK symbols 410, and each OOK symbol 410 may include an on duration and an off duration. In some examples, to detect a value (for example, a bit) indicated by an OOK symbol 410, the UE 120 may calculate the difference between an energy level (for example, average energy level) detected during a first half of the OOK symbol 410 and a second half of the OOK symbol 410. For example, as shown by reference number 425 for an OOK symbol 410h, the UE 120 may detect an energy level Eₐ during the first half of the OOK symbol 410h and an energy level E_{b} during the second half of the OOK symbol 410h. The UE 120 may subtract the energy level detected during the second half from the energy level detected during the first half (for example, Eₐ−E_{b}) to obtain the value of the bit. For example, if Eₐ−E_{b}>0, as shown in the example shown by reference number 425, the OOK symbol 410h may indicate a value of 1. Accordingly, OOK symbols 410a, 410e, 410f, and 410h each indicate a value of 1 because the energy level in the first half of OOK symbols 410a, 410e, 410f, and 410h is higher than the energy level in the second half of OOK symbols 410a, 410e, 410f, and 410h. Conversely, if Eₐ−E_{b}<0 for an OOK symbol 410, such as for OOK symbols 410b, 410c, 410d, and 410g, the OOK symbol 410 may indicate a value of 0.

In some cases, the signal 405 modulated in accordance with OOK modulation with Manchester encoding may support bit detection without thresholding. For example, without Manchester encoding, the UE 120 may be configured with one or more thresholds for comparing energy levels during each OOK symbol 410 (for example, an energy level that exceeds or otherwise satisfies a threshold may indicate a value of 1 and an energy level that is below or otherwise fails to satisfy the threshold may indicate a value of 0). However, with Manchester encoding, the UE 120 may obtain bits from OOK symbols 410 by obtaining differences in energy levels, which may not require thresholding and may be more robust against jamming and interference. Additionally, because each OOK symbol 410 includes an on duration and an off duration, each OOK symbol 410 and each OFDM symbol 415 that includes multiple OOK symbols 410 may include a balanced (for example, equal) quantity of on durations and off durations. In some examples, to detect the entire sequence indicated by the signal 405, the UE 120 may correlate each per-bit soft information with a target sequence (for example, a target LP-WUS sequence).

In some examples, the LP-WUS may include one or more overlaid sequences 420. In some cases, an overlaid sequence may be transmitted during each on duration of an OOK symbol. For example, an overlaid sequence 420a may be transmitted during an on duration of an OOK symbol 410a, and an overlaid sequence 420b may be transmitted during an on duration of an OOK symbol 410b, such that an OFDM symbol 415a spanning OOK symbols 410a and 410b includes two overlaid sequences 420. Similarly, an overlaid sequence 420c may be transmitted during an on duration of an OOK symbol 410c, and an overlaid sequence 420d may be transmitted during an on duration of an OOK symbol 410d, such that an OFDM symbol 415b spanning OOK symbols 410c and 410d includes two overlaid sequences 420. Additionally, overlaid sequences 420 (not shown) may be similarly transmitted during an on duration of an OOK symbol 410e and an OOK symbol 410f of an OFDM symbol 415c, and during an on duration of the OOK symbol 410g and the OOK symbol 410h of an OFDM symbol 415d.

In some cases, each overlaid sequence 420 may include a random phase signal, which may flatten a frequency spectrum of the LP-WUS, thereby supporting improved detection performance (for example, in frequency-selective channels). Alternatively, as shown in FIG. 4, each overlaid sequence 420 may include or may be a sequence of a set of sequences (for example, configured or defined sequences), and the sequence may correspond to a sequence of bits. For example, the overlaid sequence 420a may be a first sequence corresponding to the bit sequence ‘10,’ the overlaid sequence 420b may be a second sequence corresponding to the bit sequence ‘00,’ the overlaid sequence 420c may be a third sequence corresponding to the bit sequence ‘11,’ and the overlaid sequence 420d may be a fourth sequence corresponding to the bit sequence ‘01.’

In some examples, as shown in FIG. 4, the overlaid sequences 420 of the LP-WUS may carry the same information (for example, the same bit sequence) as the signal 405 modulated using OOK modulation. Accordingly, the overlaid sequences 420 may support faster decoding, faster data rate, or additional reliability associated with the LP-WUS relative to using an OOK-modulated signal only. In some cases, the overlaid sequences 420 may be generated in accordance with OFDM modulation using IFFT. In some aspects, an IQ WUR (for example, an OFDM WUR) may detect the overlaid sequences 420 in the time domain without an FFT, or in the frequency domain with an FFT.

In some aspects, an LP-WUS may implement one or more verification schemes (for example, as part of a verification procedure) that may confirm the LP-WUS (for example, double confirmation), which may reduce instances of false LP-WUS detection at a UE 120. In some examples, the one or more overlaid sequences 420 may be associated with a verification procedure to confirm the LP-WUS. In some aspects, overlaid sequences may be transmitted via some of the on durations of OOK symbols 410, but not all on durations. For example, a network node 110 may transmit, and the UE 120 may receive, a configuration (for example, a dynamic or semi-static configuration) that indicates which on durations may be associated with transmission of an overlaid sequence 420. In some cases, for example, the configuration may indicate one or more on durations, OOK symbols 410, or OFDM symbols 415, which may indicate to the UE 120 when the UE 120 is to monitor for overlaid sequences 420 (for example, which time resources, or which locations, to monitor). In some aspects, the on durations during which overlaid sequences 420 are transmitted may be updated, and the network node 110 may transmit an updated configuration to the UE 120.

Additionally or alternatively, the information indicated by the overlaid sequences 420 may be different from the information indicated by the signal 405. For example, the overlaid sequences 420 may indicate a different sequence (for example, a verification sequence) that may be configured to the UE 120, or a sequence that may be mapped to the information indicated by the signal 405 (for example, associated with a configured code or mapping). In some examples, the network node 110 may transmit a configuration (for example, a dynamic or semi-static configuration) that indicates the sequence to be transmitted by the overlaid sequences 420 or the mapping of the sequence to the information indicated by the signal 405. Accordingly, decoding the sequence indicated by the overlaid sequences 420 may indicate the verification of the LP-WUS.

Additionally or alternatively, the LP-WUS may include a payload (for example, data, or a payload-based signaling) during at least some on durations of the OOK symbols 410. For example, the one or more overlaid sequences 420 may indicate a payload that includes code that indicates a verification of the LP-WUS. In some aspects, the code may be implemented such that the code has a low coding rate, which may reduce processing associated with receiving the LP-WUS and may be associated with improved transmission reliability relative to using a code with a high coding rate. In some examples, the payload may be transmitted instead of the overload sequence 420 during the at least some on durations of the OOK symbols 410.

Accordingly, by including signaling in the overlaid sequences 420 that may confirm the LP-WUS in accordance with a verification procedure, the occurrence of false LP-WUS detection at the UE 120 may be reduced, which may reduce power consumption at the UE 120 associated with falsely detecting an LP-WUS and monitoring using a main radio.

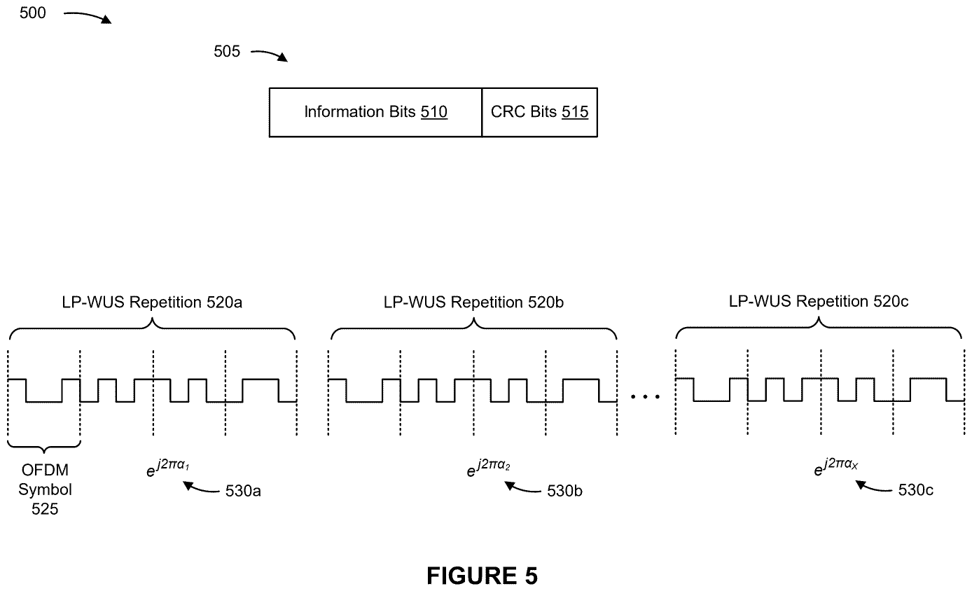

FIG. 5 is a diagram illustrating an example 500 of LP-WUS repetitions to reduce missed detection. In some aspects, the LP-WUS 505 may be associated with a verification procedure for confirmation of the LP-WUS 505 when received by a UE 120, as described herein.

In some aspects, one or more error correction bits of the LP-WUS 505 may be associated with the verification procedure for confirmation of the LP-WUS 505. For example, the LP-WUS 505 may include a set of information bits 510 and a set of CRC bits 515, which may be associated with a first scrambling operation associated with transmission error detection (for example, the set of CRC bits 515 may be scrambled in accordance with the first scrambling operation). In some aspects, the set of CRC bits 515 may be associated with additional scrambling that indicates the confirmation of the LP-WUS 505. For example, the set of CRC bits 515 may be associated with a second scrambling operation associated with the confirmation of the LP-WUS 505 (for example, the set of CRC bits 515 may be scrambled in accordance with the second scrambling operation). In some cases, the verification procedure may be or may include a verification of the set of CRC bits 515 associated with the second scrambling operation.

Additionally or alternatively, a subset of the set of CRC bits 515 may be used to confirm the LP-WUS 505. In some cases, the set of CRC bits 515 may include N bits, such that a first x bits are used for confirmation of the LP-WUS 505, and a remaining N−x bits are used for transmission error detection. In some aspects, the subset of the set of CRC bits 515 (for example, the first x bits) may include a sequence (for example, a sequence or code configured to a UE 120) that indicates the confirmation of the LP-WUS 505 (for example, when decoded by the UE 120). Additionally or alternatively, the subset of the set of CRC bits 515 or all of the set of CRC bits 515 may be scrambled in accordance with an additional scrambling operation in accordance with an identifier associated with the UE 120, which may confirm the LP-WUS 505. In some aspects, the additional scrambling operation may be in accordance with a subgroup identifier corresponding to a subgroup that includes the UE 120. Accordingly, the UE 120 may decode the first subset of the set of CRC bits 515 or all of the set of CRC bits 515 in accordance with the subgroup identifier (for example, which may be configured to the UE 120), and the successful decoding may indicate the confirmation of the LP-WUS 505.

Additionally or alternatively, in some aspects, the LP-WUS 505 may be confirmed (for example, verified) in accordance with an encoding applied to repetitions 520 of the LP-WUS 505. For example, a network node 110 may transmit multiple repetitions 520 of the LP-WUS 505, such as a first repetition 520a, a second repetition 520b, and a third repetition 520c. Each repetition 520 may be transmitted via one or more OFDM symbols 525, as described herein. While FIG. 5 illustrates three repetitions 520 as an example, a different quantity of repetitions 520 may be implemented. Each repetition 520 may indicate the information bits 510 (for example, and the CRC bits 515).

In some aspects, a phase code 530 may be applied to each repetition 520, which may indicate the confirmation of the LP-WUS 505. For example, a first phase code 530a may be applied to the first repetition 520a, a second phase code 530b may be applied to the second repetition 520b, and a third phase code 530c may be applied to the third repetition 520c.

In some aspects, the phase codes 530 to be applied to the repetitions 520 may be indicated by the network node 110 to the UE 120. Additionally or alternatively, the phase code 530 may be a function of an identifier associated with the UE 120, such as the subgroup identifier. In some aspects, the phase codes 530 may be associated with the repetition number. For example, a phase code α₁ may be applied to the repetition 520a (for example, using the term e^{jπα}^{₁}), a phase code α₂ may be applied to the repetition 520b (for example, using the term e^{jπα}^{₂}), and a phase code α_{X} may be applied to the repetition 520c (for example, using the term e^{jπα}^{_{X}}), where αₙ may be a function of the subgroup identifier, and X corresponds to the quantity of repetitions 520 of the LP-WUS 505. The UE 120 may decode each repetition 520 in accordance with the respective phase codes 530, and successful decoding of the repetitions 520 may confirm the LP-WUS 505 (for example, the verification procedure may include the decoding of the repetitions 520 in accordance with the respective phase codes 530).

Additionally or alternatively, the confirmation of the LP-WUS 505 may include reception of a signal from the network entity 110 after the LP-WUS 505. For example, after detecting the LP-WUS 505 using the LP-WUR, the UE 120 may monitor for a reference signal that confirms the LP-WUS 505 (for example, via the main radio, or via the LP-WUR). In some aspects, the reference signal may be a DMRS, such as a UE-specific DMRS or a UE-group-specific DMRS. Accordingly, if the UE 120 detects the reference signal, the UE 120 may monitor for signaling (for example, control signaling, such as via PDCCH) using the main radio, or the UE 120 may return to a sleep state if the reference signal is not detected (for example, and deactivate the main radio). In some aspects, a sequence identifier associated with the reference signal (for example, a UE-specific DMRS sequence identifier, or a UE-group-specific DMRS sequence identifier) may be associated with the subgroup identifier associated with the UE 120.

Additionally or alternatively, to confirm the LP-WUS 505, the UE 120 may wake up and monitor for signaling using the main radio. For example, the UE 120 may monitor a PDCCH using the main radio in accordance with the LP-WUS 505. In some cases, if the UE 120 does not detect control signaling via the PDCCH, the LP-WUS 505 may be considered false (for example, the detection may be a false detection), and the UE 120 may return to the sleep state and deactivate the main radio.

Accordingly, the UE 120 may activate the main radio in accordance with the verification of the LP-WUS 505, and the UE 120 may monitor for signaling (for example, control messages, such as via a PDCCH) from the network node 110 using the main radio in accordance with the confirmation of the LP-WUS 505. Consequently, if the LP-WUS 505 is not confirmed, the UE 120 may remain or return to a sleep state, which may reduce power consumption for the UE 120 even when an LP-WUS 505 is falsely detected.

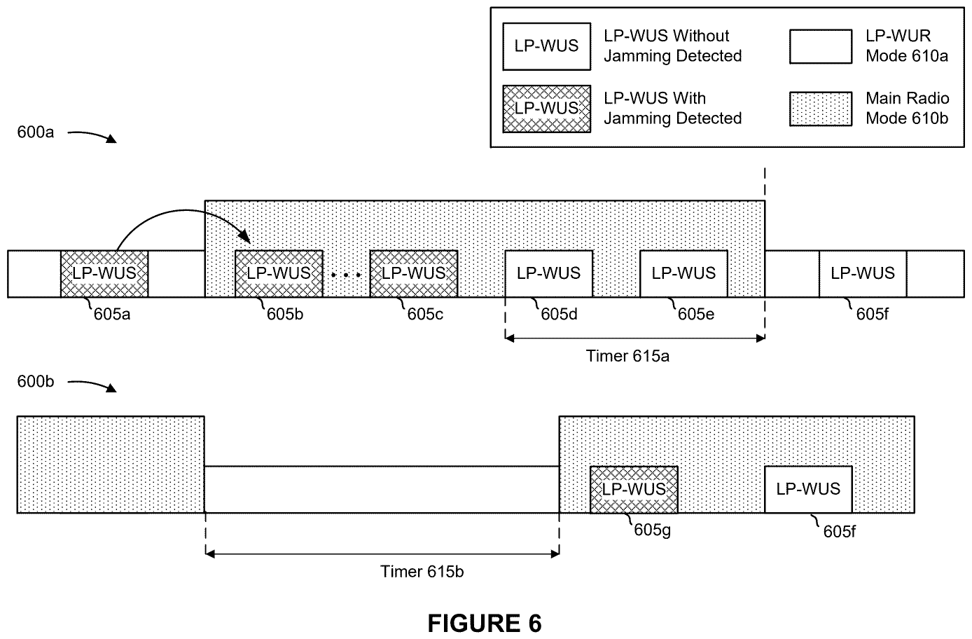

FIG. 6 is a diagram illustrating examples 600a and 600b of switching LP-WUS detection mechanisms to reduce missed detection. The example 600 illustrates techniques associated with interference or jamming detection for an LP-WUS 605. In some examples, a UE 120 may be configured with an LP-WUR mode 610a, where the UE 120 may monitor for LP-WUSs 605 using the LP-WUR, as described herein. Additionally, the UE 120 may be configured with a main radio mode 610b, where the UE 120 may monitor a larger frequency bandwidth using the main radio, as described herein.

In some aspects, the UE 120 may be configured to perform jamming or interference detection, and the UE 120 may switch between operating in accordance with the LP-WUR mode 610a or the main radio mode 610b responsive to the detection of jamming or interference. For example, as shown by the example 600a, the UE 120 may detect an LP-WUS 605a while operating in the LP-WUR mode 610a. In some examples, the UE 120 may detect jamming or interference associated with the LP-WUS 605a (for example, using a power comparison, or other jamming or interference detection procedures). In some aspects, the UE 120 may switch to operating using the main radio mode 610b responsive to the detection of jamming or interference associated with the LP-WUS 605a.

For example, the UE 120 may operate using the main radio mode 610b and may monitor for signaling (for example, control signaling via a PDCCH) responsive to receiving the LP-WUS 605a. Additionally or alternatively, the UE 120 may continue operating in the main radio mode 610b while monitoring for additional LP-WUSs 605. For example, the UE 120 may detect one or more LP-WUSs 605 that may be associated with interference or jamming, such as an LP-WUS 605b and an LP-WUS 605c. In some aspects, the main radio may be more capable of detecting the LP-WUSs 605 when interference or jamming is present. Accordingly, switching to the main radio mode 610b may improve LP-WUS 605 detection and may reduce the likelihood of missing control signaling due to a missed LP-WUS detection.

In some aspects, the UE 120 may detect an LP-WUS 605d that is not associated with jamming or interference when monitoring using the main radio mode 610b, and the UE 120 may switch from the main radio mode 610b to the LP-WUR mode 610a to monitor for additional LP-WUSs 610. In some examples, the UE 120 may switch to the LP-WUR mode 610a after a duration from detecting an LP-WUS 605 not associated with jamming or interference. For example, the UE 120 may initiate a timer 615a associated with the detection of the LP-WUS 605d without jamming detected, and the UE 120 may continue to monitor for LP-WUSs 605 in accordance with the main radio mode 610b during a duration of the timer 615a. In some cases, if the UE 120 detects an LP-WUS 605 associated with jamming or interference during the duration, the UE 120 may remain in the main radio mode 610b and may abort switching to the LP-WUR mode 610a. If the UE 120 does not detect any LP-WUS 605 associated with jamming interference during the duration of the timer 615a, the UE 120 may switch to the LP-WUR mode 610a. For example, the UE 120 may detect an LP-WUS 605e that is not associated with jamming or interference before the timer 615a expires, and the UE 120 may switch to the LP-WUR 610a to continue monitoring for LP-WUSs 605 associated with an expiration of the timer 615a (for example, after monitoring for signaling associated with the LP-WUS 605e). Accordingly, the UE 120 may monitor for an LP-WUS 605f after switching to the LP-WUR mode 610a after the jamming or interference has subsided.

In some aspects, when performing jamming or interference detection using the LP-WUR mode 610a, the UE 120 may be configured with low-complexity jamming or interference detection, such as by using power comparisons of received signals, which may be associated with relatively low power consumption (for example, in relation to complex jamming detection).

Additionally or alternatively, as shown by the example 600b, the UE 120 may be configured to switch to the main radio mode 610b after a duration. For example, the UE 120 may initiate a timer 615b when switching to operating in the LP-WUR mode 610a. The UE 120 may then switch to the main radio mode 610b in accordance with an expiration of the timer 615b. In some aspects, the UE 120 may switch to the main radio mode 610b even if the UE 120 does not detect an LP-WUS 605 while operating in the LP-WUR mode 610a. For example, the UE 120 may not detect any LP-WUS 605 if interference or jamming is severe, and the UE 120 may switch to operating in the main radio mode 610b after the expiration of the timer 615b. Accordingly, the UE 120 may monitor a PDCCH or for an LP-WUS 605 using the main radio.

For example, the UE 120 may receive an LP-WUS 605g using the main radio, which may be able to detect the LP-WUS 605g even with severe interference or jamming. In some aspects, the UE 120 may switch to operating in the LP-WUR mode 610a after detecting an LP-WUS 605f without interference (for example, after an expiration of a timer, such as the timer 615a). Consequently, the UE 120 may receive control signaling intended for the UE 120 even if jamming or interference caused the UE 120 to miss reception of one or more LP-WUSs 605.

Accordingly, by switching between operating in accordance with the LP-WUR mode 610a and the main radio mode 610b in accordance with interference or jamming detection, the UE 120 may avoid missing LP-WUS detection due to the interference or jamming, which may allow the UE 120 to monitor for control signaling intended for the UE 120 in accordance with the LP-WUS.

FIG. 7 is a flowchart illustrating an example process 700 performed, for example, at a UE or an apparatus of a UE that supports security enhancements for LP-WUS. Example process 700 is an example where the apparatus or the UE (for example, UE 120) performs operations associated with security enhancements for LP-WUS.

As shown in FIG. 7, in some aspects, process 700 may include receiving, from a network node via an LP-WUR, an LP-WUS associated with a verification procedure for confirmation of the LP-WUS (block 710). For example, the UE (such as by using communication manager 150 or reception component 902, depicted in FIG. 9) may receive, from a network node via an LP-WUR, an LP-WUS associated with a verification procedure for confirmation of the LP-WUS, as described above.

As further shown in FIG. 7, in some aspects, process 700 may include monitoring, via a main radio, for a control message from the network node in accordance with the verification procedure (block 720). For example, the UE (such as by using communication manager 150 or monitoring component 910, depicted in FIG. 9) may monitor, via a main radio, for a control message from the network node in accordance with the verification procedure, as described above.

Process 700 may include additional aspects, such as any single aspect or any combination of aspects described below or in connection with one or more other processes described elsewhere herein.

In a first additional aspect, the LP-WUS comprises a set of CRC bits associated with a first scrambling associated with transmission error detection, the verification procedure comprising a verification of at least one bit of the set of CRC bits.

In a second additional aspect, alone or in combination with the first aspect, the set of CRC bits are associated with a second scrambling associated with the verification procedure for confirmation of the LP-WUS.

In a third additional aspect, alone or in combination with one or more of the first and second aspects, the verification procedure comprises a verification of a first subset of the CRC bits for confirmation of the LP-WUS.

In a fourth additional aspect, alone or in combination with one or more of the first through third aspects, receiving the LP-WUS includes receiving a plurality of repetitions of the LP-WUS, wherein each repetition of the plurality of repetitions comprises a respective phase code associated with a subgroup identifier corresponding to the LP-WUS.

In a fifth additional aspect, alone or in combination with one or more of the first through fourth aspects, process 700 includes decoding the plurality of repetitions of the LP-WUS in accordance with the respective phase codes, wherein the verification procedure comprises decoding the plurality of repetitions in accordance with the respective phase codes.

In a sixth additional aspect, alone or in combination with one or more of the first through fifth aspects, process 700 includes receiving, via the main radio, a DMRS associated with a DMRS sequence identifier, wherein the DMRS sequence identifier is associated with the verification procedure for confirmation of the LP-WUS.

In a seventh additional aspect, alone or in combination with one or more of the first through sixth aspects, the DMRS sequence identifier is associated with a subgroup identifier that is associated with the LP-WUS, wherein monitoring for the control message via the main radio is in accordance with receiving the DMRS scrambled in accordance with the DMRS sequence identifier.

In an eighth additional aspect, alone or in combination with one or more of the first through seventh aspects, process 700 includes deactivating the main radio in accordance with failing to receive a DMRS scrambled in accordance with a DMRS sequence identifier that is associated with a subgroup identifier that is associated with the UE.

In a ninth additional aspect, alone or in combination with one or more of the first through eighth aspects, process 700 includes deactivating the main radio in accordance with failing to receive the control message from the network node.

In a tenth additional aspect, alone or in combination with one or more of the first through ninth aspects, process 700 includes initiating a timer associated with receiving the LP-WUS, wherein monitoring for the control message via the main radio is in accordance with expiration of the timer.

In an eleventh additional aspect, alone or in combination with one or more of the first through tenth aspects, the LP-WUS is a first LP-WUS, and process 700 includes monitoring, via the main radio, for a second LP-WUS in accordance with detecting jamming associated with the first LP-WUS.

In a twelfth additional aspect, alone or in combination with one or more of the first through eleventh aspects, process 700 includes initiating a timer in accordance with receiving the second LP-WUS without detection of jamming, and monitoring for a third LP-WUS via the LP-WUR in accordance with an expiration of the timer.

In a thirteenth additional aspect, alone or in combination with one or more of the first through twelfth aspects, the LP-WUS includes an on-off sequence and an overlaid sequence transmitted during an on-duration of the on-off sequence, the overlaid sequence associated with the verification procedure.

In a fourteenth additional aspect, alone or in combination with one or more of the first through thirteenth aspects, process 700 includes receiving, from the network node, a configuration indicating a portion of the on-duration during which the overlaid sequence is transmitted, wherein the verification procedure is associated with receiving the overlaid sequence during the portion of the on-duration.

In a fifteenth additional aspect, alone or in combination with one or more of the first through fourteenth aspects, process 700 includes receiving, from the network node, a configuration indicating a mapping between the overlaid sequence and one or more information bits associated with the on-off sequence, wherein the verification procedure is in accordance with the mapping.

In a sixteenth additional aspect, alone or in combination with one or more of the first through fifteenth aspects, the LP-WUS comprises one or more code bits indicated via at least one on-symbol associated with the on-duration, wherein the one or more code bits are associated with the verification procedure.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports security enhancements for LP-WUS. Example process 800 is an example where the apparatus or the network node (for example, network node 110) performs operations associated with security enhancements for LP-WUS.

As shown in FIG. 8, in some aspects, process 800 may include transmitting an LP-WUS to a UE, the LP-WUS associated with a verification procedure for confirmation of the LP-WUS (block 810). For example, the network node (such as by using communication manager 150 or transmission component 1004, depicted in FIG. 10) may transmit an LP-WUS to a UE, the LP-WUS associated with a verification procedure for confirmation of the LP-WUS, as described above.

As further shown in FIG. 8, in some aspects, process 800 may include transmitting, to the UE, a control message in accordance with the verification procedure (block 820). For example, the network node (such as by using communication manager 150 or transmission component 1004, depicted in FIG. 10) may transmit, to the UE, a control message in accordance with the verification procedure, as described above.

Process 800 may include additional aspects, such as any single aspect or any combination of aspects described below or in connection with one or more other processes described elsewhere herein.

In a first additional aspect, the LP-WUS comprises a set of CRC bits including a first scrambling associated with transmission error detection, the verification procedure associated with at least one bit of the LP-WUS.

In a second additional aspect, alone or in combination with the first aspect, the set of CRC bits are associated with a second scrambling associated with the verification procedure for confirmation of the LP-WUS.

In a third additional aspect, alone or in combination with one or more of the first and second aspects, the verification procedure comprises a verification of a first subset of the CRC bits for confirmation of the LP-WUS.

In a fourth additional aspect, alone or in combination with one or more of the first through third aspects, process 800 includes transmitting a plurality of repetitions of the LP-WUS, wherein each repetition of the plurality of repetitions comprises a respective phase code associated with a subgroup identifier that is associated with the LP-WUS, the verification procedure comprising decoding of the plurality of repetitions in accordance with the respective phase codes.

In a fifth additional aspect, alone or in combination with one or more of the first through fourth aspects, process 800 includes transmitting, to the UE, a DMRS associated with a DMRS sequence identifier, wherein the DMRS sequence identifier is associated with the verification procedure for confirmation of the LP-WUS.

In a sixth additional aspect, alone or in combination with one or more of the first through fifth aspects, the LP-WUS includes an on-off sequence and an overlaid sequence transmitted during an on-duration of the on-off sequence, the overlaid sequence associated with the verification procedure.

In a seventh additional aspect, alone or in combination with one or more of the first through sixth aspects, process 800 includes transmitting, to the UE, a configuration indicating a portion of the on-duration during which the overlaid sequence is transmitted, wherein the verification procedure is associated with receiving the overlaid sequence during the portion of the on-duration.

In an eighth additional aspect, alone or in combination with one or more of the first through seventh aspects, process 800 includes transmitting, to the UE, a configuration indicating a mapping between the overlaid sequence and one or more information bits associated with the on-off sequence, wherein the verification procedure is in accordance with the mapping.

In a ninth additional aspect, alone or in combination with one or more of the first through eighth aspects, the overlaid sequence comprises one or more code bits indicated via at least one on-symbol associated with the on-duration, wherein the one or more code bits are associated with the verification procedure.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports security enhancements for LP-WUS. The apparatus 900 may be a UE, or a UE may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 140). In some aspects, the communication manager 906 is the communication manager 150.

In some aspects, the apparatus 900 may be configured to or operable to perform one or more operations described herein in connection with FIGS. 4-6. Additionally or alternatively, the apparatus 900 may be configured to or operable to perform one or more processes described herein, such as process 700 of FIG. 7.

The reception component 902 may receive communications, such as reference signals, control information, or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the UE described above in connection with FIG. 1, such as a radio, one or more RF chains, one or more transceivers, or one or more modems, each of which may in turn be coupled with one or more antennas of the UE. In some aspects, the transmission component 904 may be co-located with the reception component 902.

The communication manager 906 may receive or may cause the reception component 902 to receive, from a network node via an LP-WUR, an LP-WUS associated with a verification procedure for confirmation of the LP-WUS. The communication manager 906 may monitor, via a main radio, for a control message from the network node in accordance with the verification procedure. In some aspects, the communication manager 906 may perform one or more operations described elsewhere herein as being performed by one or more components of the communication manager 906.

In some aspects, the communication manager 906 includes a set of components, such as a monitoring component 910, a decoding component 912, or a monitoring mode component 914. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 902 may receive, from a network node via an LP-WUR, an LP-WUS associated with a verification procedure for confirmation of the LP-WUS. The monitoring component 910 may monitor, via a main radio, for a control message from the network node in accordance with the verification procedure.

The decoding component 912 may decode the plurality of repetitions of the LP-WUS in accordance with the respective phase codes, wherein the verification procedure comprises decoding the plurality of repetitions in accordance with the respective phase codes.

The reception component 902 may receive, via the main radio, a DMRS associated with a DMRS sequence identifier, wherein the DMRS sequence identifier is associated with the verification procedure for confirmation of the LP-WUS.

The monitoring mode component 914 may deactivate the main radio in accordance with failing to receive a DMRS scrambled in accordance with a DMRS sequence identifier that corresponds to a subgroup identifier associated with the UE.

The monitoring mode component 914 may deactivate the main radio in accordance with failing to receive the control message from the network node.

The monitoring component 910 may initiate a timer associated with receiving the LP-WUS, wherein monitoring for the control message via the main radio is in accordance with expiration of the timer.

The monitoring component 910 may monitor for a second LP-WUS via the main radio in accordance with detecting jamming associated with the first LP-WUS.

The monitoring component 910 may initiate a timer in accordance with receiving the second LP-WUS without detection of jamming. The monitoring component 910 may monitor for a third LP-WUS via the LP-WUR in accordance with an expiration of the timer.

The reception component 902 may receive, from the network node, a configuration indicating a portion of the on-duration during which the overlaid sequence is transmitted, wherein the verification procedure is associated with receiving the overlaid sequence during the portion of the on-duration.

The reception component 902 may receive, from the network node, a configuration indicating a mapping between the overlaid sequence and one or more information bits associated with the on-off sequence, wherein the verification procedure is in accordance with the mapping.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports security enhancements for LP-WUS. The apparatus 1000 may be a network node, or a network node may include the apparatus 1000. In some aspects, the apparatus 1000 includes a reception component 1002, a transmission component 1004, and a communication manager 1006, which may be in communication with one another (for example, via one or more buses). As shown, the apparatus 1000 may communicate with another apparatus 1008 (such as a UE 120, a network node 110, or another wireless communication device) using the reception component 1002 and the transmission component 1004. The communication manager 1006 may be included in, or implemented via, a processing system (for example, the processing system 145). In some aspects, the communication manager 1006 is the communication manager 155.

In some aspects, the apparatus 1000 may be configured to or operable to perform one or more operations described herein in connection with FIGS. 4-6. Additionally or alternatively, the apparatus 1000 may be configured to or operable to perform one or more processes described herein, such as process 800 of FIG. 8.

The reception component 1002 may receive communications, such as reference signals, control information, or data communications, from the apparatus 1008. The reception component 1002 may provide received communications to one or more other components of the apparatus 1000, such as the communication manager 1006. In some aspects, the reception component 1002 may perform signal processing on the received communications, and may provide the processed signals to the one or more other components in a similar manner as described above in connection with FIG. 1. In some aspects, the reception component 1002 may include one or more components of the network node described above in connection with FIG. 1, such as a radio, one or more RF chains, one or more transceivers, or one or more modems, each of which may in turn be coupled with one or more antennas of the network node.

The transmission component 1004 may transmit communications, such as reference signals, control information, or data communications, to the apparatus 1008. In some aspects, the communication manager 1006 may generate communications and may transmit the generated communications to the transmission component 1004 for transmission to the apparatus 1008. In some aspects, the transmission component 1004 may perform signal processing on the generated communications, and may transmit the processed signals to the apparatus 1008 in a similar manner as described above in connection with FIG. 1. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node. In some aspects, the transmission component 1004 may be co-located with the reception component 1002.

The communication manager 1006 may transmit or may cause the transmission component 1004 to transmit an LP-WUS to a UE, the LP-WUS associated with a verification procedure for confirmation of the LP-WUS. The communication manager 1006 may transmit or may cause the transmission component 1004 to transmit, to the UE, a control message in accordance with the verification procedure. In some aspects, the communication manager 1006 may perform one or more operations described elsewhere herein as being performed by one or more components of the communication manager 1006.

In some aspects, the communication manager 1006 includes a set of components. Alternatively, the set of components may be separate and distinct from the communication manager 1006. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1004 may transmit an LP-WUS to a UE, the LP-WUS associated with a verification procedure for confirmation of the LP-WUS. The transmission component 1004 may transmit, to the UE, a control message in accordance with the verification procedure.

The transmission component 1004 may transmit a plurality of repetitions of the LP-WUS, wherein each repetition of the plurality of repetitions comprises a respective phase code associated with a subgroup identifier that is associated with the LP-WUS, the verification procedure comprising decoding the plurality of repetitions in accordance with the respective phase codes.

The transmission component 1004 may transmit, to the UE, a DMRS associated with a DMRS sequence identifier, wherein the DMRS sequence identifier is associated with the verification procedure for confirmation of the LP-WUS.

The transmission component 1004 may transmit, to the UE, a configuration indicating a portion of the on-duration during which the overlaid sequence is transmitted, wherein the verification procedure is associated with receiving the overlaid sequence during the portion of the on-duration.

The transmission component 1004 may transmit, to the UE, a configuration indicating a mapping between the overlaid sequence and one or more information bits associated with the on-off sequence, wherein the verification procedure is in accordance with the mapping.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method for wireless communication by a UE, comprising: receiving, from a network node via an LP-WUR, an LP-WUS associated with a verification procedure for confirmation of the LP-WUS; and monitoring, via a main radio, for a control message from the network node in accordance with the verification procedure.

Aspect 2: The method of Aspect 1, wherein the LP-WUS comprises a set of CRC bits associated with a first scrambling associated with transmission error detection, the verification procedure comprising a verification of at least one bit of the set of CRC bits.

Aspect 3: The method of Aspect 2, wherein the set of CRC bits are associated with a second scrambling associated with the verification procedure for confirmation of the LP-WUS.

Aspect 4: The method of any of Aspects 2 or 3, wherein the verification procedure comprises a verification of a first subset of the CRC bits for confirmation of the LP-WUS.

Aspect 5: The method of any of Aspects 1-4, wherein receiving the LP-WUS includes: receiving a plurality of repetitions of the LP-WUS, wherein each repetition of the plurality of repetitions comprises a respective phase code associated with a subgroup identifier corresponding to the LP-WUS.

Aspect 6: The method of Aspect 5, further comprising: decoding the plurality of repetitions of the LP-WUS in accordance with the respective phase codes, wherein the verification procedure comprises decoding the plurality of repetitions in accordance with the respective phase codes.

Aspect 7: The method of any of Aspects 1-6, further comprising: receiving, via the main radio, a DMRS associated with a DMRS sequence identifier, wherein the DMRS sequence identifier is associated with the verification procedure for confirmation of the LP-WUS.

Aspect 8: The method of Aspect 7, wherein the DMRS sequence identifier is associated with a subgroup identifier that is associated with the LP-WUS, wherein monitoring for the control message via the main radio is in accordance with receiving the DMRS scrambled in accordance with the DMRS sequence identifier.

Aspect 9: The method of any of Aspects 1-8, further comprising: deactivating the main radio in accordance with failing to receive a DMRS scrambled in accordance with a DMRS sequence identifier that is associated with a subgroup identifier that is associated with the UE.

Aspect 10: The method of any of Aspects 1-9, further comprising: deactivating the main radio in accordance with failing to receive the control message from the network node.

Aspect 11: The method of any of Aspects 1-10, further comprising: initiating a timer associated with receiving the LP-WUS, wherein monitoring for the control message via the main radio is in accordance with expiration of the timer.

Aspect 12: The method of any of Aspects 1-11, wherein the LP-WUS is a first LP-WUS, the method further comprising: monitoring, via the main radio, for a second LP-WUS in accordance with detecting jamming associated with the first LP-WUS.

Aspect 13: The method of Aspect 12, further comprising: initiating a timer in accordance with receiving the second LP-WUS without detection of jamming; and monitoring for a third LP-WUS via the LP-WUR in accordance with an expiration of the timer.

Aspect 14: The method of any of Aspects 1-13, wherein the LP-WUS includes an on-off sequence and an overlaid sequence transmitted during an on-duration of the on-off sequence, the overlaid sequence associated with the verification procedure.

Aspect 15: The method of Aspect 14, further comprising: receiving, from the network node, a configuration indicating a portion of the on-duration during which the overlaid sequence is transmitted, wherein the verification procedure is associated with receiving the overlaid sequence during the portion of the on-duration.

Aspect 16: The method of any of Aspects 14 or 15, further comprising: receiving, from the network node, a configuration indicating a mapping between the overlaid sequence and one or more information bits associated with the on-off sequence, wherein the verification procedure is in accordance with the mapping.

Aspect 17: The method of any of Aspects 14-16, wherein the LP-WUS comprises one or more code bits indicated via at least one on-symbol associated with the on-duration, wherein the one or more code bits are associated with the verification procedure.

Aspect 18: A method of wireless communication performed by a network node, comprising: transmitting an LP-WUS to a UE, the LP-WUS associated with a verification procedure for confirmation of the LP-WUS; and transmitting, to the UE, a control message in accordance with the verification procedure.

Aspect 19: The method of Aspect 18, wherein the LP-WUS comprises a set of CRC bits including a first scrambling associated with transmission error detection, the verification procedure associated with a verification of at least one bit of the LP-WUS.

Aspect 20: The method of Aspect 19, wherein the set of CRC bits are associated with a second scrambling associated with the verification procedure for confirmation of the LP-WUS.

Aspect 21: The method of any of Aspects 19 or 20, wherein a first subset of the CRC bits is associated with the verification procedure for confirmation of the LP-WUS.

Aspect 22: The method of any of Aspects 18-21, further comprising: transmitting a plurality of repetitions of the LP-WUS, wherein each repetition of the plurality of repetitions comprises a respective phase code associated with a subgroup identifier that is associated with the LP-WUS, the verification procedure comprising a decoding the plurality of repetitions in accordance with the respective phase codes.

Aspect 23: The method of any of Aspects 18-22, further comprising: transmitting, to the UE, a DMRS associated with a DMRS sequence identifier, wherein the DMRS sequence identifier is associated with the verification procedure for confirmation of the LP-WUS.

Aspect 24: The method of any of Aspects 18-23, wherein the LP-WUS includes an on-off sequence and an overlaid sequence transmitted during an on-duration of the on-off sequence, the overlaid sequence associated with the verification procedure.

Aspect 25: The method of Aspect 24, further comprising: transmitting, to the UE, a configuration indicating a portion of the on-duration during which the overlaid sequence is transmitted, wherein the verification procedure is associated with receiving the overlaid sequence during the portion of the on-duration.

Aspect 26: The method of any of Aspects 24 or 25, further comprising: transmitting, to the UE, a configuration indicating a mapping between the overlaid sequence and one or more information bits associated with the on-off sequence, wherein the verification procedure is in accordance with the mapping.

Aspect 27: The method of any of Aspects 24-26, wherein the LP-WUS comprises one or more code bits indicated via at least one on-symbol associated with the on-duration, wherein the one or more code bits are associated with the verification procedure.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-27.

Aspect 29: An apparatus for wireless communication at a device, the apparatus comprising one or more memories and one or more processors coupled to the one or more memories, the one or more processors configured to cause the device to perform the method of one or more of Aspects 1-27.

Aspect 30: An apparatus for wireless communication, the apparatus comprising at least one means for performing the method of one or more of Aspects 1-27.

Aspect 31: A non-transitory computer-readable medium storing code for wireless communication, the code comprising instructions executable by one or more processors to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

Aspect 33: A device for wireless communication, the device comprising a processing system that includes one or more processors and one or more memories coupled with the one or more processors, the processing system configured to cause the device to perform the method of one or more of Aspects 1-27.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-27.

Aspect 35: A device comprising a processing system that includes one or more processors and one or more code-storing memories coupled with the one or more processors, the processing system configured to cause the device to perform the method of one or more of Aspects 1-27.

Aspect 36: A device comprising a processing system that includes processor circuitry and code-storing memory circuitry, the processing system configured to cause the device to perform the method of one or more of Aspects 1-27.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node via a low-power wake-up radio (LP-WUR), a low-power wake-up signal (LP-WUS) associated with a verification procedure for confirmation of the LP-WUS; and
monitor, via a main radio, for a control message from the network node in accordance with the verification procedure.

2. The UE of claim 1, wherein the LP-WUS comprises a set of cyclic redundancy check (CRC) bits associated with a first scrambling associated with transmission error detection, the verification procedure comprising a verification of at least one bit of the set of CRC bits.

3. The UE of claim 2, wherein the set of CRC bits are associated with a second scrambling associated with the verification procedure for confirmation of the LP-WUS.

4. The UE of claim 2, wherein the verification procedure comprises a verification of a first subset of the CRC bits for confirmation of the LP-WUS.

5. The UE of claim 1, wherein the processing system, to cause the UE to receive the LP-WUS, is configured to cause the UE to:
receive a plurality of repetitions of the LP-WUS, wherein each repetition of the plurality of repetitions comprises a respective phase code associated with a subgroup identifier corresponding to the LP-WUS.

6. The UE of claim 5, wherein the processing system is configured to cause the UE to:
decode the plurality of repetitions of the LP-WUS in accordance with the respective phase codes, wherein the verification procedure comprises decoding the plurality of repetitions in accordance with the respective phase codes.

7. The UE of claim 1, wherein the processing system is configured to cause the UE to:
receive, via the main radio, a demodulation reference signal (DMRS) associated with a DMRS sequence identifier, wherein the DMRS sequence identifier is associated with the verification procedure for confirmation of the LP-WUS.

8. The UE of claim 7, wherein the DMRS sequence identifier is associated with a subgroup identifier that is associated with the LP-WUS, wherein monitoring for the control message via the main radio is in accordance with receiving the DMRS scrambled in accordance with the DMRS sequence identifier.

9. The UE of claim 1, wherein the processing system is configured to cause the UE to:
deactivate the main radio in accordance with failing to receive a demodulation reference signal (DMRS) scrambled in accordance with a DMRS sequence identifier that is associated with a subgroup identifier that is associated with the UE.

10. The UE of claim 1, wherein the processing system is configured to cause the UE to:
deactivate the main radio in accordance with failing to receive the control message from the network node.

11. The UE of claim 1, wherein the processing system is configured to cause the UE to:
initiate a timer associated with receiving the LP-WUS, wherein monitoring for the control message via the main radio is in accordance with expiration of the timer.

12. The UE of claim 1, wherein the LP-WUS is a first LP-WUS, and wherein the processing system is configured to cause the UE to:
monitor, via the main radio, for a second LP-WUS in accordance with detecting jamming associated with the first LP-WUS.

13. The UE of claim 12, wherein the processing system is configured to cause the UE to:
initiate a timer in accordance with receiving the second LP-WUS without detection of jamming; and
monitor for a third LP-WUS via the LP-WUR in accordance with an expiration of the timer.

14. The UE of claim 1, wherein the LP-WUS includes an on-off sequence and an overlaid sequence transmitted during an on-duration of the on-off sequence, the overlaid sequence associated with the verification procedure.

15. The UE of claim 14, wherein the processing system is configured to cause the UE to:
receive, from the network node, a configuration indicating a portion of the on-duration during which the overlaid sequence is transmitted, wherein the verification procedure is associated with receiving the overlaid sequence during the portion of the on-duration.

16. The UE of claim 14, wherein the processing system is configured to cause the UE to:
receive, from the network node, a configuration indicating a mapping between the overlaid sequence and one or more information bits associated with the on-off sequence, wherein the verification procedure is in accordance with the mapping.

17. The UE of claim 14, wherein the LP-WUS comprises one or more code bits indicated via at least one on-symbol associated with the on-duration, wherein the one or more code bits are associated with the verification procedure.

18. A method for wireless communication by a user equipment (UE), comprising:
receiving, from a network node via a low-power wake-up radio (LP-WUR), a low-power wake-up signal (LP-WUS) associated with a verification procedure for confirmation of the LP-WUS; and
monitoring, via a main radio, for a control message from the network node in accordance with the verification procedure.

19. The method of claim 18, wherein the LP-WUS comprises a set of cyclic redundancy check (CRC) bits associated with a first scrambling associated with transmission error detection, the verification procedure associated with a verification of at least one bit of the set of CRC bits.

20. An apparatus for wireless communication, comprising:
means for receiving, from a network node via a low-power wake-up radio (LP-WUR), a low-power wake-up signal (LP-WUS) associated with a verification procedure for confirmation of the LP-WUS; and
means for monitoring, via a main radio, for a control message from the network node in accordance with the verification procedure.
